(19) United States
(12) Patent Application Publication
(10) Pub. No.: US 2025/0307791 A1
(43) Pub. Date: Oct. 2, 2025

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Kento KOBAYASHI, Kanagawa (JP)

(73) Assignee: FUJIFILM Business Innovation Corp., Tokyo (JP)

(21) Appl. No.: 18/799,549

(22) Filed: Aug. 9, 2024

(30) Foreign Application Priority Data
Mar. 26, 2024 (JP) 2024-050303

(51) Int. Cl. G06Q 20/14

(52) U.S. Cl. CPC G06Q 20/145

(57) ABSTRACT

An information processing system includes a processor configured to: set, if a renewal fee is not paid by the end of a usage contract period, a grace period until the use of all functions of the host system will be prohibited; and prohibit the use of some functions of the host system during the set grace period.

### CROSS-REFERENCE TO RELATED APPLICATIONS

This application is based on and claims priority under 35 USC 119 from Japanese Patent Application No. 2024-050303 filed Mar. 26, 2024.

### BACKGROUND

### (i) Technical Field

The present disclosure relates to an information processing system, an information processing method, and a non-transitory computer readable medium.

### (ii) Related Art

Japanese Unexamined Patent Application Publication No. 2009-006487 describes a printer configured to store fees for printing operations reliably with a simple configuration.

Japanese Unexamined Patent Application Publication No. 2021-076993 describes a billing management apparatus configured to provide appropriate relief to users who have missed a payment deadline for billed services according to the duration of use of the billed services.

### SUMMARY

Aspects of non-limiting embodiments of the present disclosure relate to avoiding an immediate loss of use when a usage contract period expires.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to: set, if a renewal fee is not paid by the end of a usage contract period, a grace period until the use of all functions of the information processing system will be prohibited; and prohibit the use of some functions of the host system during the set grace period.

### BRIEF DESCRIPTION OF THE DRAWINGS

An exemplary embodiment of the present disclosure will be described in detail based on the following figures, wherein:

FIG. 1 is a diagram illustrating a system configuration of an information processing system according to an exemplary embodiment of the present disclosure;

FIG. 2 is a block diagram illustrating a hardware configuration of an image forming apparatus according to an exemplary embodiment of the present disclosure;

FIG. 3 is a block diagram illustrating a functional configuration of an image forming apparatus according to an exemplary embodiment of the present disclosure;

FIG. 4 is a diagram for explaining a process when applying a device lock in an image forming apparatus;

FIG. 5 is a diagram illustrating display examples on a display during normal operation and during a grace period;

FIG. 6 is a diagram illustrating display examples on a display during normal operation and during a grace period; and

FIG. 7 is a flowchart for explaining the flow of a process when applying a device lock in an image forming apparatus.

### DETAILED DESCRIPTION

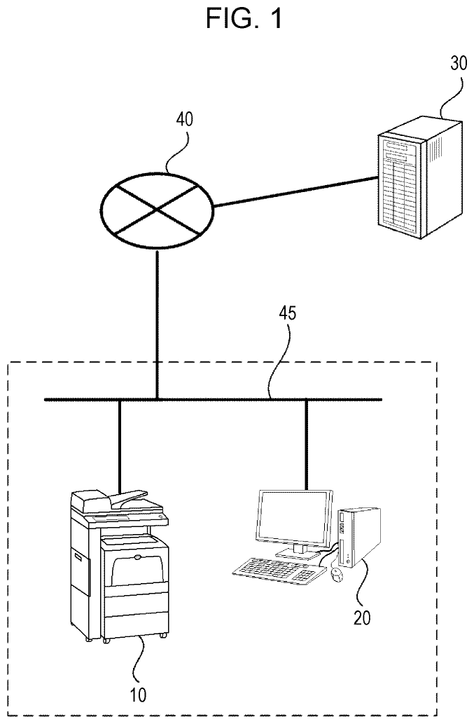

Hereinafter, exemplary embodiments for carrying out the technology of the present disclosure will be described in detail and with reference to the drawings. FIG. 1 is a diagram illustrating a system configuration of an information processing system according to an exemplary embodiment.

As illustrated in FIG. 1, the information processing system according to the exemplary embodiment includes an image forming apparatus 10, a user terminal 20, and a management server 30.

The image forming apparatus 10 is an apparatus referred to as a multi-function peripheral, and includes multiple functions such as a copy function, a print function, a fax function, and a scan function. The image forming apparatus 10 is one example of an information processing system in the technology of the present disclosure.

The user terminal 20 is connected to the image forming apparatus 10 via a local network 45, and is a terminal for using the functions of the image forming apparatus 10.

The management server 30 is a server for managing the conditions of use of the image forming apparatus 10. The management server 30 is connected to the local network 45 through the Internet 40.

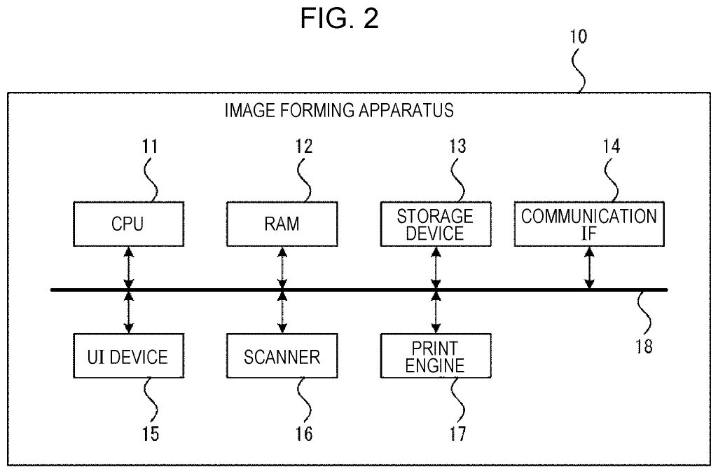

Next, a hardware configuration of the image forming apparatus 10 in an information processing system according to the exemplary embodiment is illustrated in FIG. 2.

As illustrated in FIG. 2, the image forming apparatus 10 is provided with a central processing unit (CPU) 11, random access memory (RAM) 12, a storage device 13 such as a hard disk drive, a communication interface (abbreviated to IF) 14, a user interface (abbreviated to UI) device 15 including a touch panel or liquid crystal display and a keyboard, a scanner 16, and a print engine 17. These structural elements are interconnected through a control bus 18.

The communication IF 14 transmits and receives data to and from external apparatuses and the like over the Internet 40. The UI device 15 accepts instruction input from a user. The scanner 16 reads a document loaded into the image forming apparatus 10 as image data. The print engine 17 prints an image onto a recording medium such as printing paper via steps such as charging, exposing, developing, transferring, and fusing.

The CPU 11 is a processor that controls operations by the image forming apparatus 10 by executing predetermined processes on the basis of a control program stored in the RAM 12 or the storage device 13. Note that although the CPU 11 is described as reading out and executing a control program stored in the RAM 12 or the storage device 13 in the exemplary embodiment, the control program is not limited thereto. The control program may also be provided by being recorded onto a computer-readable recording medium. For example, the program may be provided by being recorded on an optical disc, such as a Compact Disc-Read-Only Memory (CD-ROM) or a Digital Versatile Disc-Read-Only Memory (DVD-ROM), or by being recorded on a semiconductor memory, such as Universal Serial Bus (USB) memory or a memory card. Additionally, the control program may also be acquired from an external apparatus over a communication channel connected to the communication interface 14.

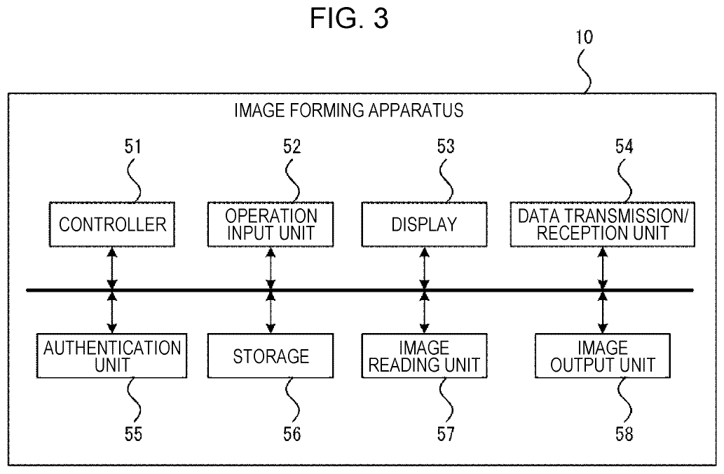

FIG. 3 is a block diagram illustrating a functional configuration of the image forming apparatus 10 achieved through the execution of the above control program.

As illustrated in FIG. 3, the image forming apparatus 10 according to the exemplary embodiment is provided with a controller 51, an operation input unit 52, a display 53, a data transmission/reception unit 54, an authentication unit 55, storage 56, an image reading unit 57, and an image output unit 58.

The controller 51 controls overall operations by the image forming apparatus 10, such as controlling the reading of a document image by the image reading unit 57 and controlling the outputting of print data from the image output unit 58, on the basis of instruction input from the user.

The operation input unit 52 inputs information on various operations performed by the user. The display 53 is controlled by the controller 51 to display various information to the user. The data transmission/reception unit 54 transmits and receives data to and from external apparatuses such as the user terminal 20 and the management server 30. The authentication unit 55 executes an authentication process with respect to a user attempting to use the image forming apparatus 10.

The storage 56 stores various data such as the control program, for example. The image reading unit 57, under control by the controller 51, reads a document image from a loaded document. The image output unit 58, under control by the controller 51, outputs an image onto a recording medium such as printing paper.

One usage pattern of the image forming apparatus 10 involves, for example, the user and a service provider conclude a usage contract, and the user periodically pays the service provider a fee, whereby the service provider lends the image forming apparatus 10 to the user and offers a maintenance service that provides consumables for using the image forming apparatus 10 and provides troubleshooting and the like when trouble occurs.

In such a usage pattern, for the user to continue using the image forming apparatus 10, the user may be required to renew the usage contract by paying a renewal fee by the end of the usage contract period.

If the renewal fee is not paid by the user by the end of the usage contract period, the service provider may stop the functions of the image forming apparatus 10. Such a function is referred to as a device lock.

If it is assumed that the user has unintentionally missed the renewal fee payment, there is a problem in that stopping the functions of the image forming apparatus 10 with the device lock may make the image forming apparatus 10 unusable when the user wants to use the image forming apparatus 10.

To address such a problem, if the renewal fee is not paid by the end of the usage contract period, the controller 51 of the image forming apparatus 10 according to the exemplary embodiment sets a grace period until the use of all functions of the image forming apparatus 10 will be prohibited, and prohibits the use of some functions of the image forming apparatus 10 during the set grace period.

Specifically, the image forming apparatus 10 receives device lock instruction information, including information about the end date and time of the usage contract period, from the management server 30 in advance.

In addition to the information about the end date and time of the usage contract period, the device lock instruction information includes information such as the cumulative usage contract period for the user, the presence or absence of a device lock in the past, and conditions of use by the user in the past.

In applying the device lock after the end date and time of the usage contract period has passed, the controller 51 sets the grace period and prohibits the use of some functions during the set grace period.

The image forming apparatus 10 provides multiple functions, such as a copy function, a print function, a fax function, and a scan function. During the grace period, from among the above multiple functions, the copy function is left unchanged while the use of the remaining functions is prohibited, for example, thereby allowing the user to use the copy function even when the usage contract period is expired.

In the image forming apparatus 10 according to the exemplary embodiment, during the grace period, the controller 51 may also prohibit the use of some functions while leaving unchanged the function with the highest usage frequency.

Also, during the grace period, the controller 51 may prohibit the use of some functions while leaving unchanged a function that has been selected by the user.

Also, during the grace period, the controller 51 may restrict the use of some commands for a function of which use is not prohibited.

Herein, “restrict the use of some commands for a function” means imposing a restriction on the use of an optional function included within a single function, such as prohibiting color printing in the copy function or prohibiting the printing or 10 or more copies in the copy function, for example.

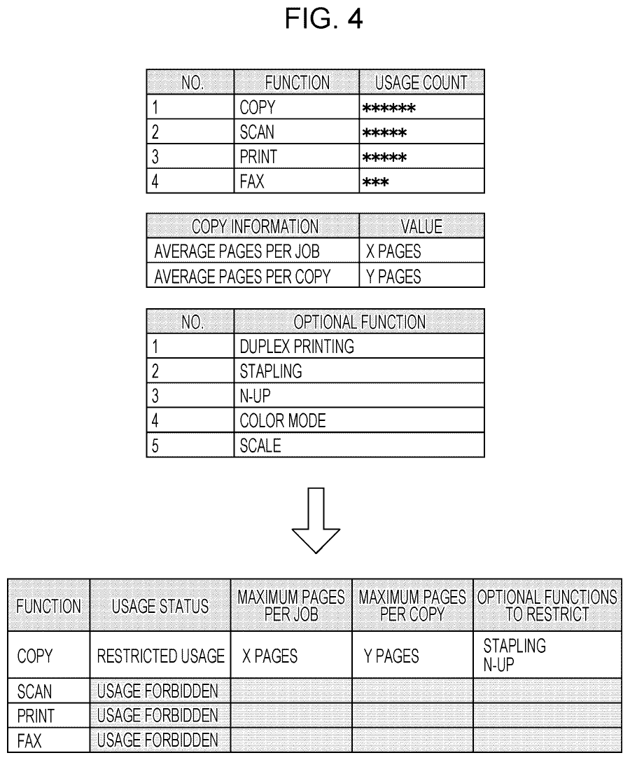

As one example, in the image forming apparatus 10 according to the exemplary embodiment, the functions of which use is to be prohibited and the optional functions on which to impose a restriction in a usable function are set according to information such as a usage count for each function, usage information about each function, and a usage count for each optional function in each function, as illustrated in FIG. 4.

In the example in FIG. 4, use is prohibited for functions other than the copy function which has the highest usage count, and even in the usable copy function, the copying of a number of copies that exceeds the average number of pages per job and the average number of pages per copy is prohibited, and furthermore, use is prohibited for a stapling function which has the second-highest usage count and for an N-up function which has the third-highest usage count.

The controller 51 may also set the length of the grace period according to the conditions of use by the user.

In this case, the controller 51 may set the length of the grace period according to the usage period and/or a usage fee that the user paid in the past, or according to the number of payment defaults.

The controller 51 may also set the display appearance of an operation screen during the grace period to a display appearance that is different from the display appearance of the operation screen during the usage contract period.

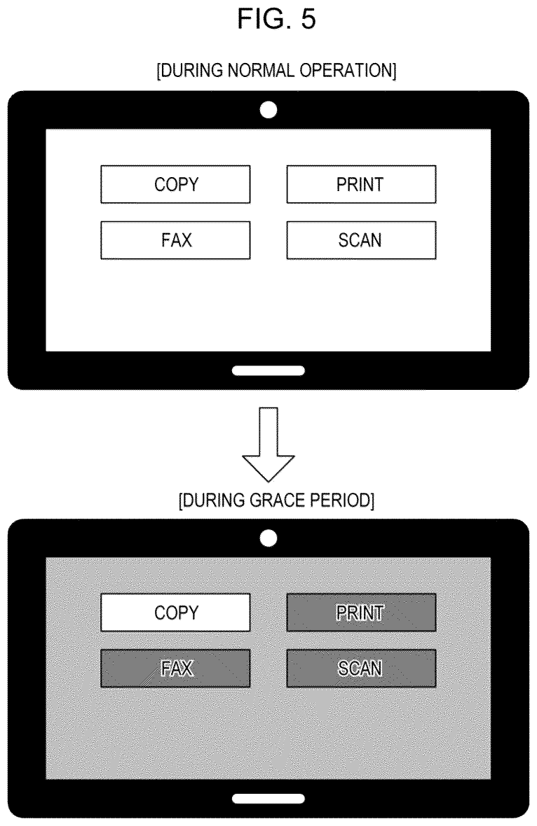

In this case, as illustrated in FIG. 5, for an operation screen to be displayed on the display 53, the controller 51 may set the background color during the grace period to a color that is different from the background color during the usage contract period.

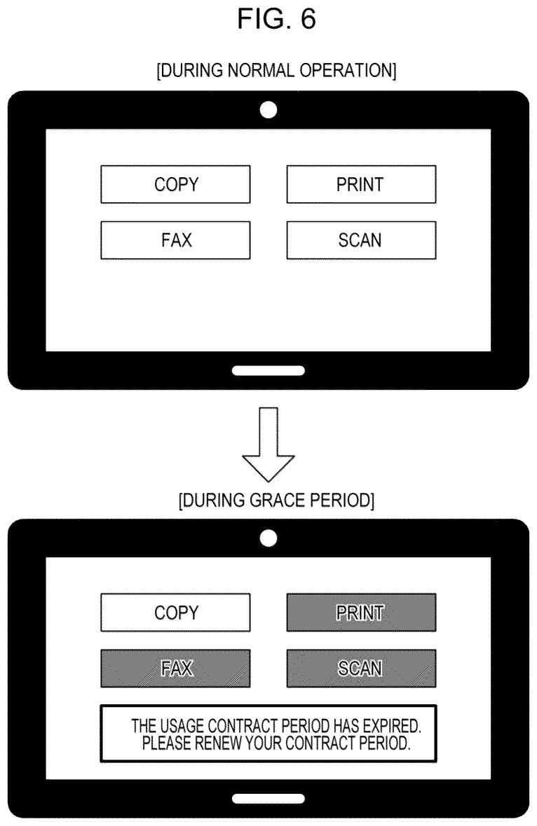

Also, as illustrated in FIG. 6, the controller 51 may also display, on the display 53, information indicating that the renewal fee has not been paid. In the example in FIG. 6, the following message is displayed as the information indicating that the renewal fee has not been paid: “The usage contract period has expired. Please renew your contract period.”

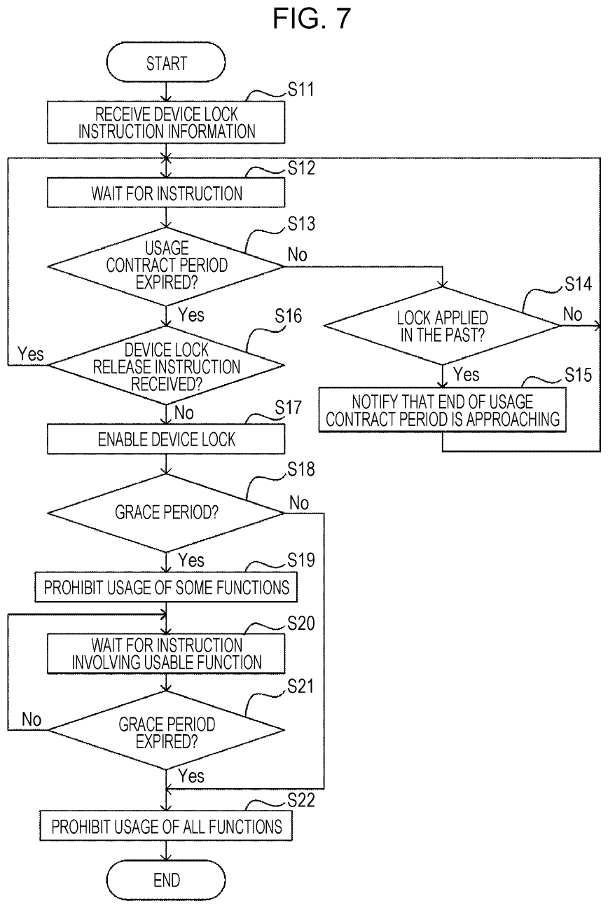

Next, the flow of a process when applying a device lock in the image forming apparatus 10 according to the exemplary embodiment will be described with reference to the flowchart in FIG. 7.

First, in step S11, the controller 51 receives device lock instruction information, including information such as the end date and time of the usage contract period, from the management server 30.

Next, in step S12, the controller 51 waits for an instruction from the user.

Next, in step S13, the controller 51 determines whether or not the end date and time of the usage contract period has passed.

In step S13, if it is determined that the end date and time of the usage contract period has not passed, in step S14, the controller 51 determines whether or not the device lock has been applied to the user in the past.

In step S14, if it is determined that the device lock has been applied in the past, in step S15, the controller 51 issues a notification indicating that the end of the usage contract period is approaching, and proceeds to step S12. The notification in step S15 may be in any form, such as the display of a message on the display 53 or a notification by sound or speech.

In step S14, if it is determined that the device lock has not been applied in the past, the controller 51 proceeds to step S12.

Also, in step S13, if it is determined that the end date and time of the usage contract period has passed, in step S16, the controller 51 determines whether or not a device lock release instruction is received from the management server 30. Note that the device lock release instruction is transmitted from the management server 30 to the image forming apparatus 10 when the usage contract period is renewed.

In step S16, if it is determined that the device lock release instruction is received from the management server 30, the controller 51 proceeds to step S12.

In step S16, if it is determined that the device lock release instruction is not received, in step S17, the controller 51 enables the device lock.

Next, in step S18, the controller 51 determines whether or not the grace period is to be given, based on the conditions of use by the user in the past.

In step S18, if it is determined that the grace period is not to be given, in step S22, the controller 51 prohibits the use of all functions, and ends the process.

In step S18, if it is determined that the grace period is to be given, in step S19, the controller 51 prohibits the use of some functions.

Next, in step S20, the controller 51 waits for an instruction from the user involving a usable function.

Next, in step S21, the controller 51 determines whether or not the end date and time of the grace period has passed.

In step S21, if it is determined that the end date and time of the grace period has not passed, the controller 51 proceeds to step S20.

In step S21, if it is determined that the end date and time of the grace period has passed, in step S22, the controller 51 prohibits the use of all functions, and ends the process.

### Exemplary Modifications

The foregoing describes an information processing system according to one exemplary embodiment of the present disclosure, but the technology of the present disclosure is not limited to the exemplary embodiment above, and modifications may also be made, as appropriate.

In the exemplary embodiment above, the term “processor” refers to hardware in a broad sense. Examples of the processor include general processors (e.g., CPU: Central Processing Unit), and dedicated processors (e.g., GPU: Graphics Processing Unit, ASIC: Application Specific Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the exemplary embodiment above, and may be changed.

Also, the exemplary embodiment above is described using the case of applying the technology of the present disclosure to an image forming apparatus of the multi-function peripheral type, but the present disclosure is limited thereto, and the technology of the present disclosure may also be applied to any of various information processing systems, such as printers, scanners, cable TV set-top boxes, or mobile phones, for example.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising a processor configured to:
set, if a renewal fee is not paid by the end of a usage contract period, a grace period until the use of all functions of the information processing system will be prohibited; and
prohibit the use of some functions of the host system during the set grace period.
   (((2)))

The information processing system according to (((1))), wherein during the grace period, the processor is configured to prohibit the use of some functions while leaving unchanged a function with the highest usage frequency.

(((3)))

The information processing system according to (((1))), wherein during the grace period, the processor is configured to prohibit the use of some functions while leaving unchanged a function that has been selected by a user.

(((4)))

The information processing system according to any one of (((1))) to (((3))), wherein during the grace period, the processor is configured to restrict the use of some commands for a function of which use is not prohibited.

(((5)))

The information processing system according to any one of (((1))) to (((4))), wherein the processor is configured to set the length of the grace period according to the conditions of use by a user.

(((6)))

The information processing system according to (((5))), wherein the processor is configured to set the length of the grace period according to a usage period and/or a usage fee that a user paid in the past.

(((7)))

The information processing system according to (((5))), wherein the processor is configured to set the length of the grace period according to the number of payment defaults.

(((8)))

The information processing system according to any of (((1))) to (((7))), wherein the processor is configured to set a display appearance of an operation screen during the grace period to a display appearance that is different from the display appearance of the operation screen during the usage contract period.

(((9)))

The information processing system according to (((8))), wherein the processor is configured to set a background color of the operation screen during the grace period to a color that is different from the background color of the operation screen during the usage contract period.

(((10)))

The information processing system according to (((8))) or (((9))), wherein the processor is configured to display, on the operation screen during the grace period, information indicating that the renewal fee has not been paid.

(((11)))

A program causing a computer to execute a process comprising:
setting, if a renewal fee is not paid by the end of a usage contract period, a grace period until the use of all functions of an information processing system will be prohibited; and
prohibiting the use of some functions of the host system during the set grace period.

What is claimed is:

1. An information processing system comprising:
a processor configured to:
set, if a renewal fee is not paid by the end of a usage contract period, a grace period until the use of all functions of the information processing system will be prohibited; and
prohibit the use of some functions of the host system during the set grace period.

2. The information processing system according to claim 1, wherein during the grace period, the processor is configured to prohibit the use of some functions while leaving unchanged a function with the highest usage frequency.

3. The information processing system according to claim 1, wherein during the grace period, the processor is configured to prohibit the use of some functions while leaving unchanged a function that has been selected by a user.

4. The information processing system according to claim 1, wherein during the grace period, the processor is configured to restrict the use of some commands for a function of which use is not prohibited.

5. The information processing system according to claim 1, wherein the processor is configured to set the length of the grace period according to the conditions of use by a user.

6. The information processing system according to claim 5, wherein the processor is configured to set the length of the grace period according to a usage period and/or a usage fee that a user paid in the past.

7. The information processing system according to claim 5, wherein the processor is configured to set the length of the grace period according to the number of payment defaults.

8. The information processing system according to claim 1, wherein the processor is configured to set a display appearance of an operation screen during the grace period to a display appearance that is different from the display appearance of the operation screen during the usage contract period.

9. The information processing system according to claim 8, wherein the processor is configured to set a background color of the operation screen during the grace period to a color that is different from the background color of the operation screen during the usage contract period.

10. The information processing system according to claim 8, wherein the processor is configured to display, on the operation screen during the grace period, information indicating that the renewal fee has not been paid.

11. An information processing method comprising:
setting, if a renewal fee is not paid by the end of a usage contract period, a grace period until the use of all functions of an information processing system will be prohibited; and
prohibiting the use of some functions of the host system during the set grace period.

12. A non-transitory computer readable medium storing a program causing a computer to execute a process comprising:
setting, if a renewal fee is not paid by the end of a usage contract period, a grace period until the use of all functions of an information processing system will be prohibited; and
prohibiting the use of some functions of the host system during the set grace period.
